(19) United States
(12) Patent Application Publication
(10) Pub. No.: US 2009/0160876 A1
(43) Pub. Date: Jun. 25, 2009

(54) VIRTUAL CONTACT GROUPS

(75) Inventors: Steven A. King, Round Rock, TX (US); James D. Allen, Austin, TX (US); Martin F. Slatnick, Austin, TX (US)

Correspondence Address: IBM CORPORATION;INTELLECTUAL PROPERTY LAW, 11501 BURNET ROAD, AUSTIN, TX, 78758, US

(73) Assignee: International Business Machines Corporation

(21) Appl. No.: 11/962,344

(22) Filed: Dec. 21, 2007

(51) Int. Cl. G09G 5/00

(52) U.S. Cl. 345/676

(57) ABSTRACT

A computer-implementable method, system and computer-usable medium includes a virtual contact group that can be dynamically created, in response to a particular user input such as, for example, registration by the user with a particular organization and/or facility. The virtual contact group generally includes a plurality of key or designated personnel. The virtual contact group is associated with the user. The designated personnel are then allowed to communicate electronically with one another within the virtual contact group to provide a coordinate service to the user. The virtual contact group is defined based on a user profile associated with the user. The virtual contact group can be stored within one or more memory locations of a computing device associated with one or more designated personnel among the virtual contact group. Such a computing device can be, for example, a wireless communication device capable communicating with the network and/or a server associated with the network.

### TECHNICAL FIELD

Embodiments are generally related to data-processing devices and methods. Embodiments also relate in general to the field of computers and similar technologies, and in particular to software utilized in this field. In addition, embodiments relate to techniques for creating and managing the provision of services to users.

### BACKGROUND OF THE INVENTION

As more and more people rely on their electronic devices, including, for example, their cellular telephones, personal digital assistants (PDAs), personal computers (PCs), laptops, pagers, and the like, they are relying less and less on outdated “paper and pen” methods of communicating with their friends, family members and colleagues. As a result, they are also relying less on paper and pen methods of storing contact information associated with those parties. Instead of maintaining a physical address book in order to keep track of all of the contact information for various individuals or businesses, people are storing phone numbers, addresses, E-mail addresses, and the like, in various applications on their electronic devices.

An example of such an application is the Contacts application offered by many communications devices currently on the market. Using this application, individuals can create, store and communicate electronic business cards (e.g., vCards) including information, such as, an individual's name, job title, company, business/home/fax/mobile phone number, business/home address and/or E-mail address. A vCard is essentially an electronic business card that follows a defined file format standard and may be communicated to other parties, for example, via E-mail messages and/or the World Wide Web. Another example is a simple phonebook application installed on a mobile or cellular telephone that enables the mobile phone user to create an entry for each of his or her contacts that lists that contact's home, mobile and/or business telephone number.

Using these applications, people can maintain an electronic record of the contact information of their friends, family members and colleagues, as well as various businesses or services they contact frequently. In addition, these applications may make the process of actually communicating with a respective contact much faster and easier. In particular, the user is often able to simply select the contact entry in the particular application being used, in order to, for example, initiate a voice call to the corresponding phone number, or send an E-mail, Instant Message (IM) or Short Message Service (SMS) or Multimedia Messaging Service (MMS) message to the corresponding E-mail address.

In many instances, however, it may be beneficial for certain actions or routines to be performed with respect to a selected contact and in particular a group of contacts who perform similar services for a user or on behalf of a user.

A need, therefore, exists for a way to enhance the functionality of electronic device phonebooks or contact lists in a manner that enables the implementation of dynamic lists of contacts and groups associated with these contacts, particular in the context of organizations such as legal services, medical services, and so forth.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system and computer-usable medium.

It is another aspect of the present invention to provide for an improved method, system and computer-usable medium for creating and managing the provision of services to users.

The aforementioned aspects and other objectives and advantages can now be achieved as described herein. A computer-implementable method, system and computer-usable medium are disclosed. A virtual contact group can be dynamically created, in response to a particular user input such as, for example, registration by the user with a particular organization and/or facility. This can be accomplished physically at the facility itself and/or over a computer network. The virtual contact group generally includes a plurality of key or designated personnel. The virtual contact group is associated with the user. The designated personnel are then allowed to communicate electronically with one another within the virtual contact group to provide a coordinate service to the user. The virtual contact group is defined based on a user profile associated with the user. The virtual contact group can be stored within one or more memory locations of a computing device associated with one or more designated personnel among the virtual contact group. Such a computing device can be, for example, a wireless communication device capable communicating with the network and/or a server associated with the network.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system in which the present invention may be embodied.

FIG. 2 illustrates a schematic view of a software system including an operating system, application software, and a user interface for carrying out the present invention;

FIG. 3 depicts a pictorial representation of a network of data processing systems in which aspects of the present invention may be implemented;

FIG. 4 illustrates a high-level flow chart of operations depicting logical operational steps of a method for creating and managing a virtual contact group, in accordance with a preferred embodiment; and

FIG. 5 illustrates a system for providing a virtual contact group, in accordance with a preferred embodiment.

### DETAILED DESCRIPTION

The particular values and configurations discussed in these non-limiting examples can be varied and are cited merely to illustrate at least one embodiment and are not intended to limit the scope of such embodiments.

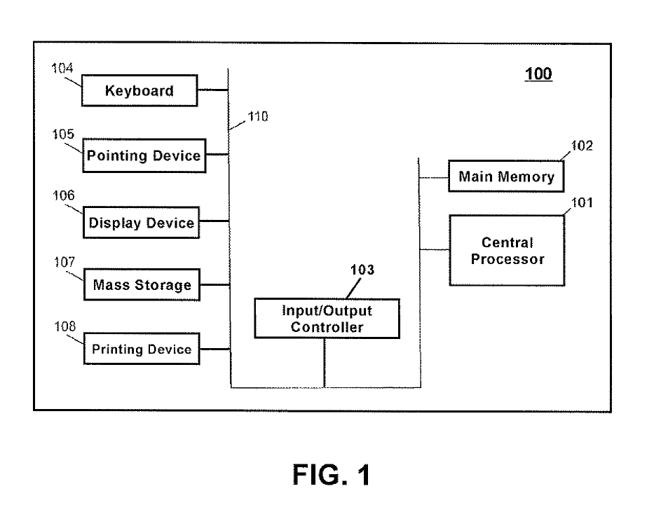

FIGS. 1-3 are provided as exemplary diagrams of data processing environments in which embodiments of the present invention may be implemented. It should be appreciated that FIGS. 1-3 are only exemplary and are not intended to assert or imply any limitation with regard to the environments in which aspects or embodiments of the present invention may be implemented. Many modifications to the depicted environments may be made without departing from the spirit and scope of the present invention.

As depicted in FIG. 1, the present invention may be embodied in the context of a data-processing system 100 comprising a central processor 101, a main memory 102, an input/output controller 103, a keyboard 104, a pointing device 105 (e.g. mouse, track ball, pen device, or the like), a display device 106, and a mass storage 107 (e.g., hard disk). Additional input/output devices, such as a printing device 108, may be included in the data-processing system 100 as desired. As illustrated, the various components of the data-processing system 100 communicate through a system bus 110 or similar architecture.

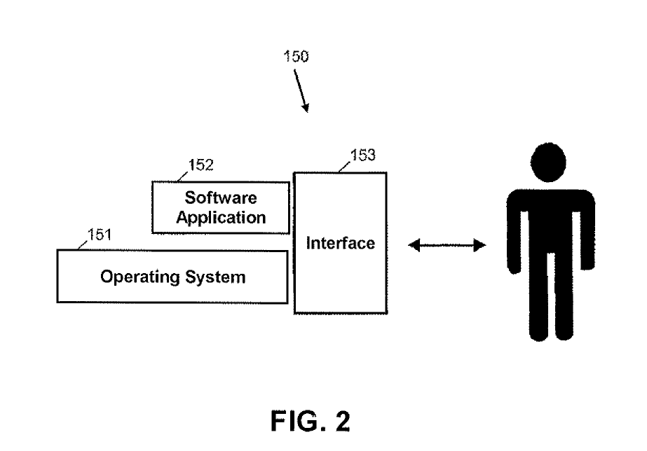

Illustrated in FIG. 2, a computer software system 150 is provided for directing the operation of the data-processing system 100. Software system 150, which is stored in system memory 102 and on disk memory 107, includes a kernel or operating system 151 and a shell or interface 153. One or more application programs, such as application software 152, may be “loaded” (i.e., transferred from storage 107 into memory 102) for execution by the data-processing system 100. The data-processing system 100 receives user commands and data through user interface 153; these inputs may then be acted upon by the data-processing system 100 in accordance with instructions from operating module 151 and/or application module 152.

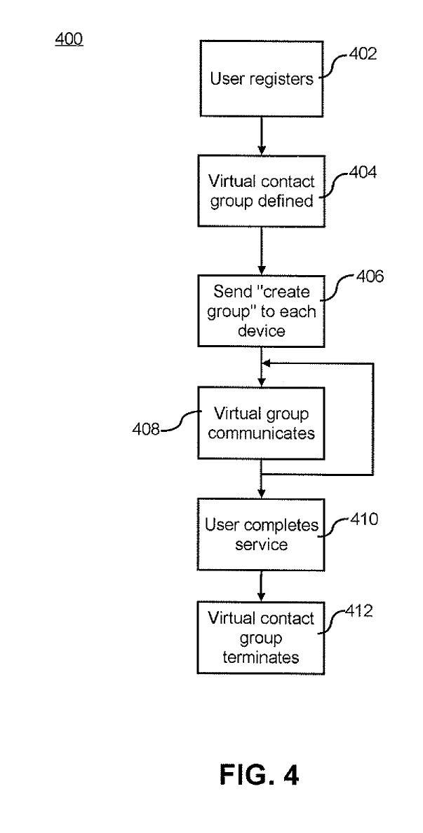

The interface 153, which is preferably a graphical user interface (GUI), also serves to display results, whereupon the user may supply additional inputs or terminate the session. In an embodiment, operating system 151 and interface 153 can be implemented in the context of a “Windows” system. Application module 152, on the other hand, can include instructions, such as the various logical operations of method 400 depicted in FIG. 4. Thus, the methods disclosed herein can be implemented in the context of an application or software module.

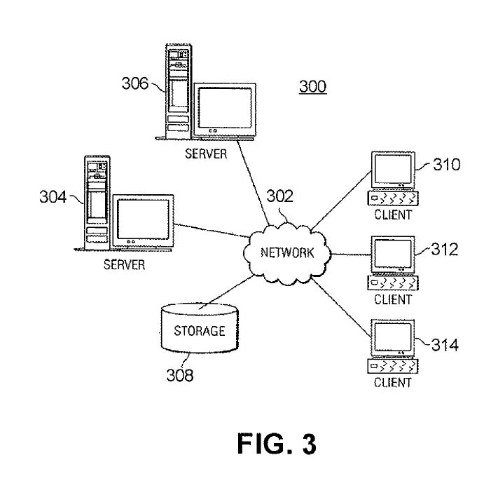

FIG. 3 depicts a pictorial representation of a network of data processing systems in which aspects of the present invention may be implemented. Network data processing system 300 is a network of computers in which embodiments of the present invention may be implemented. Network data processing system 300 contains network 302, which is the medium used to provide communications links between various devices and computers connected together within network data processing system 100. Network 102 may include connections, such as wire, wireless communication links, or fiber optic cables.

In the depicted example, server 304 and server 306 connect to network 302 along with storage unit 308. In addition, clients 310, 312, and 314 connect to network 302. These clients 310, 312, and 314 may be, for example, personal computers or network computers. Data-processing system 100 depicted in FIG. 1 can be, for example, a client such as client 310, 312, and/or 314. Alternatively, data-processing system 100 can be implemented as a server, such as servers 304 and/or 306, depending upon design considerations.

In the depicted example, server 304 provides data, such as boot files, operating system images, and applications to clients 310, 312, and 314. Clients 310, 312, and 314 are clients to server 304 in this example. Network data processing system 300 may include additional servers, clients, and other devices not shown. Specifically, clients may connect to any member of a network of servers which provide equivalent content.

In the depicted example, network data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 300 also may be implemented as a number of different types of networks, such as for example, an intranet, a local area network (LAN), or a wide area network (WAN). FIG. 1 is intended as an example, and not as an architectural limitation for different embodiments of the present invention.

The following description is presented with respect to embodiments of the present invention, which can be embodied in the context of a data-processing system such as data-processing system 100, computer software system 150 and data processing system 300 and network 302 depicted respectively FIGS. 1-3. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments which follows is for purposes of illustration and not considered a limitation.

FIG. 4 illustrates a high-level flow chart of operations depicting logical operational steps of a method 400 for creating and managing a virtual contact group, in accordance with a preferred embodiment. The process begins, as indicated at block 402, in which the users registers with a particular organization or facility (e.g., a medical facility). This can be accomplished at the facility itself and/or via user input provided through a computer network such as, for example, the network data processing system 300 depicted in FIG. 3. Thereafter as depicted at block 404, the virtual contact group can be created and defined. That is, the virtual contact group is dynamically created, in response to a particular user input, such as registration as indicated at block 402. The virtual contact group includes one or more key or designated personnel who are capable of providing particular services (e.g., medical care) to the user. The virtual contact group is defined based on a user profile associated with the user.

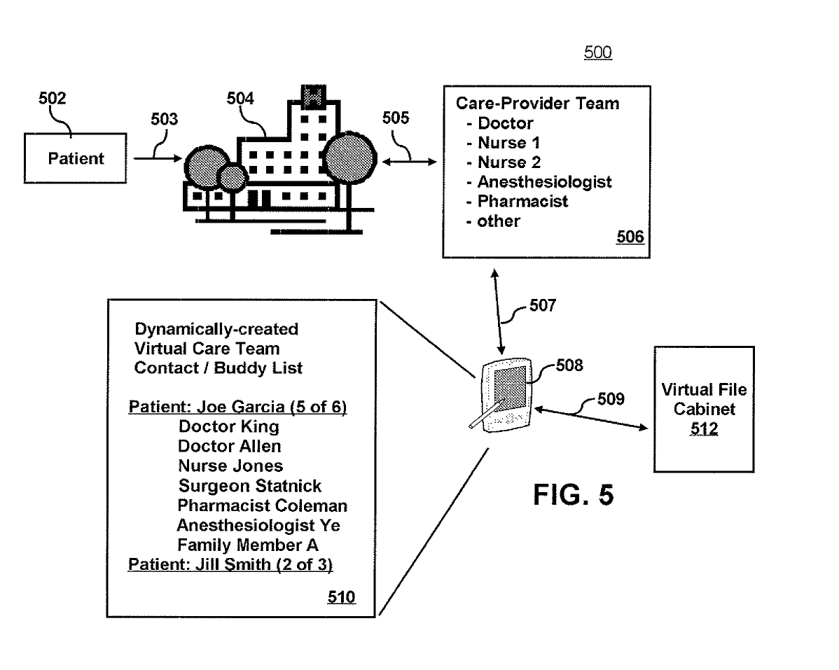

Next, as indicated at block 406, an operation can be processed in which the created virtual contact group is sent to each device associated with each of the key/designated personnel within the virtual contact group. Thereafter, as depicted at block 408, the members of the virtual contact group can communicate among themselves (or with other personnel) regarding service to the user. Following implementation of the operation depicted at block 408, the service to the user is completed as indicated at block 410. Next, as indicated at block 412, the virtual contact group terminates and the process ends. An example of one possible virtual contact group is virtual contact group 500 illustrated in FIG. 5.

FIG. 5 illustrates a system 500 for providing a virtual contact group 506, in accordance with a preferred embodiment. System 500 generally includes a patient 502 (i.e., a user) who can register at a medical facility 504. Arrow 503 indicates that the patient has registered at the medical facility 504. Arrow 505 indicates that a “virtual” patient-care team or virtual contact group 506 is defined based the needs of the patient 502 or a user profile. The virtual contact group 506 can include, for example, a doctor, nurses, pharmacists, etc. These are key/designated personnel who make up the virtual contact group 506. Each member of the virtual contact group 506 preferably has his or her own mobile communication device 508. Arrow 507 represents wireless communication with the mobile communication device 508, such as, for example, Bluetooth, Infrared, 802.11x, a wireless network, cellular network, and so forth. The mobile communication device 508 is cable of instant messaging and/or e-mail of text data and/or graphics. Mobile communication device 508 (e.g., a combined PDA/Cellular Telephone) can display data such as, for example, medical records and or a dynamically-created virtual care team list 510. A “hot link” to medical records can thus provide a “virtual file cabinet” for all relevant documents associated with the patient 502.

System 500 and method 400 together thus provide a methodology for implementing a virtual contact group such as the virtual contact group 506. First, the patient registers at a medical facility for a medical procedure. Next, a dynamic, virtual contact list can be created on the mobile devices (e.g., device 508) of the caregivers who make up the virtual contact group 506. The virtual contact group 506 can be associated with the patient based on the caregivers' profiles previously defined in the context of system 500. Also interested parties not automatically assigned by the system 500 (i.e. family member) can also be added to the virtual contact group 506. Communications are managed between the caregiver team via Instant Messaging, e-Mail of text and/or graphic information. The dynamic contact list (or buddy list) 510 is active until the patient checks out. Note that the aforementioned scenario is healthcare-related, but it can be appreciated that the creation of the dynamic contact list 510 linked to an object can applicable to many other scenarios. The virtual contact group 506 may be related to other activities, such as, for example, a group of lawyers or a group of engineers, software designers and so forth.

Another option for expanding system 500 is the implementation of a hotlink to a virtual cabinet 512. For example, in the context of a medical scenario, the “virtual” file cabinet 512 may contain medical records related to the patient 502. Such a virtual file cabinet which can be accessed via the mobile device 509 can contain all relevant documents associated with the patient 502. This allows care-providers (or other people based on the industry/scenario) to access MRI images, CT scans, medical history, and other pertinent data in the “virtual file cabinet” 502 associated with the person's name that is the base of the virtual contact group. If the industry/scenario is a crisis management team; for example, then the virtual file cabinet 502 associated with virtual contact group could include floor plans, blue prints, etc. for example. Note that the term “virtual” as utilized herein refers generally to some a software implementation. “Virtual” is a term that describes some item, service, or other element that reflects or mimics a real version of that thing. Virtual reality, for example, is a computer-generated approximation of a real setting and/or series of events without true physical dimensions.

The core concept described herein thus can allow for the creation of a virtual contact group that is linked to a user (e.g. a patient in a medical scenario). Each person in the group is a key care-provider and can IM with others as needed in the virtual group to provide coordinated care. The dynamic contact list is terminated when the patient no longer needs care. However, it is important to note that although a healthcare scenario is described, the core concept of the dynamic group creation linked to an event or entity applies to other scenarios. An alternative scenario would be the event to be an emergency situation. In this case a virtual contact group would be created on the mobile devices or laptops for police officers, fire fighters, emergency recovery and care teams, etc. The group would exist for the duration needed to collaborate/communication and then it would be terminated

One implementation is based on providing the ability to define a set of people needed to easily communicate via instant messaging, e-mail, etc. For example, if the patient has a broken leg then the “virtual care community” would be orthopedic doctors and nurses. If the patient was in to deliver a child then the “virtual care community” would be OB/GYN doctors, nurses, etc.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A computer-implementable method, comprising:
dynamically creating a virtual contact group, in response to a particular user input by said user, wherein said virtual contact group includes a plurality of designated personnel;
associating said virtual contact group with said user; and
allowing said designated personnel to communicate electronically with one another within said virtual contact group to provide a coordinate service to said user.

2. The computer-implementable method of claim 1 wherein allowing said designated personnel to communicate electronically with one another within said virtual contact group to provide a coordinate service to said user, further comprises:
allowing said designated personnel to communicate electronically with one another utilizing instant messaging.

3. The computer-implementable method of claim 1 wherein allowing said designated personnel to communicate electronically with one another within said virtual contact group to provide a coordinate service to said user, further comprises:
allowing said designated personnel to communicate electronically with one another utilizing e-mail.

4. The computer-implementable method of claim 1 further comprising:
defining said virtual contact group based on a user profile associated with said user.

5. The computer-implementable method of claim 1 further comprising:
storing said virtual contact group within at least one memory location of a computing device associated with at least one designated personnel among said virtual contact group.

6. The computer-implementable method of claim 1 wherein said computing device comprises a wireless communication device that is capable of communicating with said network.

7. The computer-implementable method of claim 1 wherein said computing device comprises a server associated with said network.

8. The computer-implementable method of claim 1 further comprising associating a virtual file cabinet with said user wherein said virtual file cabinet is accessible by a user via said computing device in communication with said network.

9. A system, comprising:
a processor;
a data bus coupled to said processor; and
a computer-usable medium embodying computer code, said computer-usable medium being coupled to said data bus, said computer program code comprising instructions executable by said processor and configured for:
dynamically creating a virtual contact group, in response to a particular user input by said user, wherein said virtual contact group includes a plurality of designated personnel;
associating said virtual contact group with said user; and
allowing said designated personnel to communicate electronically with one another within said virtual contact group to provide a coordinate service to said user.

10. The system of claim 9 wherein allowing said designated personnel to communicate electronically with one another within said virtual contact group to provide a coordinate service to said user, further comprises:
allowing said designated personnel to communicate electronically with one another utilizing instant messaging.

11. The system of claim 9 wherein allowing said designated personnel to communicate electronically with one another within said virtual contact group to provide a coordinate service to said user, further comprises,
allowing said designated personnel to communicate electronically with one another utilizing e-mail.

12. The system of claim 9 wherein said instructions are further configured for:
defining said virtual contact group based on a user profile associated with said user.

13. The system of claim 9 wherein said instructions are further configured for:
storing said virtual contact group within at least one memory location of a computing device associated with at least one designated personnel among said virtual contact group.

14. The system of claim 9 wherein said instructions are further configured for:
associating a virtual file cabinet with said user wherein said virtual file cabinet is accessible by a user via said computing device in communication with said network.

15. A computer-usable medium embodying computer program code, said computer program code comprising computer executable instructions configured for:
dynamically creating a virtual contact group, in response to a particular user input by said user, wherein said virtual contact group includes a plurality of designated personnel;
associating said virtual contact group with said user; and
allowing said designated personnel to communicate electronically with one another within said virtual contact group to provide a coordinate service to said user.

16. The computer-usable medium of claim 15 wherein allowing said designated personnel to communicate electronically with one another within said virtual contact group to provide a coordinate service to said user, further comprises:
allowing said designated personnel to communicate electronically with one another utilizing instant messaging.

17. The computer-usable medium of claim 15 wherein allowing said designated personnel to communicate electronically with one another within said virtual contact group to provide a coordinate service to said user, further comprises:
allowing said designated personnel to communicate electronically with one another utilizing e-mail.

18. The computer-usable medium of claim 15 wherein said embodied computer program code further comprises computer executable instructions configured for:
defining said virtual contact group based on a user profile associated with said user.

19. The computer-usable medium of claim 15 wherein said embodied computer program code further comprises computer executable instructions configured for:
storing said virtual contact group within at least one memory location of a computing device associated with at least one designated personnel among said virtual contact group.

20. The computer-usable medium of claim 15 wherein said embodied computer program code further comprises computer executable instructions configured for:
associating a virtual file cabinet with said user wherein said virtual file cabinet is accessible by a user via said computing device in communication with said network.
